(19) United States
(12) Patent Application Publication
(10) Pub. No.: US 2010/0051813 A1
(43) Pub. Date: Mar. 4, 2010

(54) MEASUREMENT ACCESSORY WITH MULTIPLE TRANSMISSION-REFLECTIONS USED FOR INFRARED SPECTROMETER

(75) Inventors: Shoujun Xiao, Nanjing (CN); Hongbo Liu, Nanjing (CN)

Correspondence Address: SCHMEISER, OLSEN & WATTS, 22 CENTURY HILL DRIVE, SUITE 302, LATHAM, NY, 12110, US

(73) Assignee: NANJING UNIVERSITY, Nanjing, Jiangsu (CN)

(21) Appl. No.: 12/515,018

(22) PCT Filed: Nov. 12, 2007
(86) PCT No.: PCT/CN07/03186

§ 371 Date: May 15, 2009

(30) Foreign Application Priority Data
Nov. 16, 2006 (CN) 200610097859.4
Nov. 12, 2007 (CN) PCT/CN2007/003186

(51) Int. Cl. G01N 21/01; G01N 21/25

(52) U.S. Cl. 250/339.07

(57) ABSTRACT

A measurement accessory with multiple transmission-reflections uses for an infrared spectrometer, laid accessory is arranged in the sample cavity of the infrared spectrometer. Said accessory includes two parallel plane mirrors (7, 8) and a sample holder fixed between the two mirrors (7, 8). Said sample holder can fix the sample piece (9) between the two plane mirrors (7, 8) and make the sample piece parallel with plane mirrors (7, 8). During measuring, the infrared ray emitted from infrared spectrometer (17) forms a certain angle incident to the space between said plane mirrors and reflects for several times between the two parallel plane mirrors (7, 8) and the sample piece (9) is measured with multiple transmission-reflections by the infrared spectrometer. Then the infrared spectrometer (20) enters into the detector of infrared spectrometer.

### TECHNICAL FIELD

The present invention belongs to the spectral measurement technology field, which relates to the measurement of internal trace compositions or the surface interface trace compositions of a type of infrared (semi-) transparent materials. It is an accessory used in the infrared spectrometer.

### BACKGROUND OF THE INVENTION

The infrared materials e.g. silicon, germanium, gallium arsenide, are the common electronic materials in the semiconductor industry, and widely used in many fields such as biosensing, sensors, solar cells, molecular identification. The surface finish of such materials is an important procedure for each application. The infrared spectrum can measure the molecular composition and orientation of the surface finish film as well as the factors of filming quality, which is an important surface analysis means. When the thickness of film is only at a nanometer level (e.g. the thickness of a molecular monolayer is only about 1 nm), there will be a great difficulty in the infrared measurement for the reasons described as follows: (1). The compositions to be tested is in a too small quantity, and the infrared absorption intensity is very weak; (2) When the infrared spectrometer reaches the surface of materials, the transmission and reflection will happen at the same time, and the loss in energy will result in a decrease in the signal-to-noise ratio. The same reasons as described above also exist in the measurement of internal trace compositions contained in the materials. Therefore, the commonly used transmission and reflection measuring method can not be used effectively for measuring the surface trace compositions of the infrared materials. Furthermore, such kind of difficulties cause many research workers to give up the surface features of the infrared spectrum. As a result, the application of infrared spectrum has been restricted.

At present, the most common method for surface finish measurement is the multiple internal reflections. Such method is to use an attenuated total reflection (ATR) silicon crystal as the substrate of reactive molecular film with two sides of the silicon crystal chamfered by an angle of 45°. The infrared spectrometer enters the silicon from one end, and leaves the crystal from the other end to reach the detector after the multiple internal reflections are taken place. It is possible to detect the molecules on the surface within a thickness of about l m. With increasing the number of internal reflection times, the absorption intensity is increased. However, the silicon crystal which needs to be used in this method is expensive, and liable to be damaged during the reaction. Moreover, it can not be used as the substrate for directly making the preparations for the subsequent components, which will bring about a great trouble in the experimental operation. The other method is to use GATR accessory (GATR, Harrick Scientific Corporation) which has been developed in recent years, using the germanium crystal as the ATR crystal and pressing the silicon piece on the crystal for measurement with the infrared spectrometer at an incidence angle of 65° (greater than the critical angle of 60° for total reflection between the germanium and silicon. Theoretically, the electric field between two materials with a high refractive index will be increased to a great extent while the infrared absorption signals will be enhanced accordingly. However, since during the actual measurement, it is inevitable for the gap to exist between the germanium crystal and the sample to be tested even if a large pressure is applied, the intensity of signals will be reduced to a large extent. Meanwhile, a great pressure is liable to damage the surface composition of the germanium crystal and the samples to be tested. Moreover, if there is a bit difference in the control of pressure for each measurement, it will be difficult to repeat the test result.

Therefore, a very good solution to the surface trace composition measurement of infrared materials has not been found. An appropriate test method has not been found yet in terms of the signal-to-noise ratio, repeatability of data, difficulty and readiness level of test operations, costly practical characteristics, etc.

### SUMMARY OF THE INVENTION

The purpose of the present invention is to design a measurement accessory with the infrared spectrum appropriate to the measurement of surface and internal trace compositions of the materials that have features of being infrared (semi) transparent. The use of this accessory will make the spectrum have a high signal-to-noise ratio and a good repeatability. The accessory is of easy and simple operation and costly practical.

The technical scheme of the present invention is described as follows:

A measurement accessory with multiple transmission-reflections uses for an infrared spectrometer, laid accessory is arranged in the sample chamber of the infrared spectrometer. Said accessory includes two parallel plane mirrors and a sample holder fixed between the two mirrors. Said sample holder can fix the sample piece between the two plane mirrors and make the sample piece parallel with plane mirrors. During measuring, the infrared spectrometer emitted from infrared spectrometer forms a certain angle incident to the space between said plane mirrors and reflects for several times between the two parallel plane mirrors and the sample piece is measured with multiple transmission-reflections by the infrared spectrometer. Then the infrared spectrometer enters into the detector of infrared spectrometer.

In the above-mentioned measurement accessory with the multiple transmission-reflections for the infrared spectrometer, the said plane mirrors are provided with a parallel displacement part for adjusting the distance between two mirrors.

In the above-mentioned measurement accessory with the multiple transmission-reflections for the infrared spectrometer, the said two plane mirrors and the sample holder are provided with a common rotary platform for adjusting the incidence angle of infrared spectrometer entering into the plane mirrors.

In the above-mentioned measurement accessory with the multiple transmission-reflections for the infrared spectrometer, there are outgoing guide mirrors, the position and angle of which are changeable, in the rear of the infrared spectrometer path of the said two plane mirrors, which are used for adjusting the direction of the infrared beam to guide it into the detector as much as possible in order to enhance the ray signals to be received by the detector.

In the above-mentioned measurement accessory with the multiple transmission-reflections for the infrared spectrometer, there are two incoming guide mirrors, the position and angle of which are changeable, in front of the infrared spectrometer path of the said two plane mirrors, which is provided for adjusting the infrared beam to enter into two plane mirrors. The incidence angle of the infrared beam for measuring is changeable.

The design specified as follows can also be used in the above-said measurement accessory with multiple transmission-reflections for the infrared spectrometer:

The above-mentioned measurement accessory with the multiple transmission-reflections for the infrared spectrometer has a rectangular housing. There is an inlet at the front end of the rectangular housing to let the infrared beam to enter. On the base plate of rectangular housing, there is a plane incoming guide mirror inclined upwards to provide an angle of 60°-88° included between the incoming infrared beam and the normal of plane mirror surface. There is a rectangular opening of sample holder on the top-plate of rectangular housing. Caved-in shoulders are provided, at least, at two opposite sides of the sample holder opening. When the sample holder is placed into the sample holder opening, the shoulders can support the sample holder. The sample holder is a plate of a certain thickness with a shape matching the sample holder opening. There is a sample opening at the center of the sample holder. There are caved-in shoulders around the sample opening. When a sample is positioned into the sample opening, the shoulders can support the sample. The sample holder is covered by mirror A, one of two parallel mirrors, and the mirror face of parallel mirror A is downward. The distance between the sample and parallel mirror A is determined by the caved-in depth of the shoulders around the sample opening. There is parallel mirror B, one of two parallel mirrors, directly under the sample holder, which is in parallel with parallel mirror A. The face of parallel mirror B is upward. The length of parallel mirror B is smaller than that of the sample opening in order to allow the incoming infrared beam after reflection of the incoming guide mirror to enter into the sample opening of the sample holder, and to go to the outgoing-ray guide mirror after multiple reflections taking place between two parallel mirrors. The outgoing ray guide mirror is a plane mirror inclined downwards, which is located on the baseplate of rectangular housing. There is an outlet of outgoing infrared beam at the rear end of rectangular housing. The outgoing ray guide mirrors guide the outgoing infrared beam to the detector of infrared spectrometer.

For the above-said measurement accessory with multiple transmission-reflections for infrared spectrometer, there are spacers under the said parallel mirror B, which are provided for ensuring the distance between parallel mirror B and the sample.

For the above-said measurement accessory with multiple transmission-reflections for infrared spectrometer, there are wedge spacers under the said infrared beam guide mirrors and the outgoing ray guide mirrors, which are provided for ensuring an accurate angle of inclination for the infrared beam guide mirrors and the outgoing ray guide mirrors.

For the above-said measurement accessory with multiple transmission-reflections for infrared spectrometer, it is simple and easy to replace the sample, and the distance between two parallel mirrors is fixed to ensure a parallel relation between two parallel mirrors and between the sample and the parallel mirrors, resulting in a better repeatability of the measurement results. It is easy to make preparations. Several sample holders with different caved-in depths of shoulders around the sample opening and several spacers of different heights used for parallel mirror B can be fabricated. When it is required to change the distance between two parallel mirrors, the distance between two parallel mirrors can be changed simply by replacing the spacers used for the sample holder and parallel mirror B.

The measurement accessory with multiple transmission-reflections for infrared spectrometer in the present invention utilizes the infrared (semi) transparent characteristics of the infrared materials, combines the testing methods of the reflection and transmission spectrum and uses the multiple transmission-reflections to raise the signal-to-noise ratio of spectrums. It is simple in operation. It is not necessary to make special treatment to the samples and use an expensive total reflection crystal. The repeatability of measurement results is good. It can be used not only for testing the trace composition of the surface, but also for measuring the internal trace compositions of materials.

### BRIEF DESCRIPTION OF ACCOMPANYING DRAWINGS

FIG. 1 Over-all structure and ray path schematic diagram of measurement accessory with multiple transmission-reflections for infrared spectrometer in Embodiment Example 1

FIG. 2. Plane mirror section and test sample laying-up diagram of measurement accessory with multiple transmission-reflections for infrared spectrometer

FIG. 3. plane mirror 7 fixing method schematic diagram of measurement accessory with multiple transmission-reflections for infrared spectrometer

FIG. 4. plane mirror 8 fixing method schematic diagram of measurement accessory with multiple transmission-reflections for infrared spectrometer

FIG. 5. sample holding method schematic diagram of measurement accessory with multiple transmission-reflections for infrared spectrometer

FIG. 6. Guide mirror section structure schematic diagram of measurement accessory with multiple transmission-reflections for infrared spectrometer

FIG. 7. p-Polarized infrared spectrogram of N-hydroxysuccinimidyl ester (NHS-ester) molecular monolayer on Si surface for the test using the said accessory in the present invention with an incidence angle of 70° and different distances between the mirror faces: (a)1.5 mm; (b)2 mm; (c)2.5 mm; (d)3 mm

FIG. 8. p-Polarized infrared spectrogram of NHS-ester molecular monolayer on Si surface for the test using the said accessory in the present invention with different incidence angles: (a)55°; (b)60°; (C)65°; (d)70°; (e)75°; (f)80°

FIG. 9. Structure and ray path schematic diagram of measurement accessory with multiple transmission-reflections for infrared spectrometer in Embodiment Example 2

FIG. 10. Structure schematic diagram of measurement accessory with multiple transmission-reflections for infrared spectrometer in Embodiment Example 3

FIG. 11. sample holder structure schematic diagram Embodiment Example 3

FIG. 12. infrared Spectrum of poly-silicon piece measurement in Embodiment Example 3

### DESCRIPTION OF THE PREFERRED EMBODIMENTS

### Embodiment Example 1: Measurement Accessory with Multiple Transmission—Reflections for Infrared Spectrometer

The ray path designed for this accessory can be used in various types of the present infrared spectrometers. The ray path said in the following embodiment example is designed on the basis of the infrared spectrometer manufactured by Bruker Company. The transmission bracket used on the Bruker infrared spectrometer will be used as the base for fixing the accessory. The infrared beam from the spectrometer will be focused into a very small spot at the center of the sample cavity, and then diverged to reach the detector. In this embodiment Example, the said focus point is used as the infrared beam of this accessory, and in the design, the outgoing ray is remained in the original diverging state before reaching the detector. During the sample test, the incidence angle is controlled accurately with a step motor.

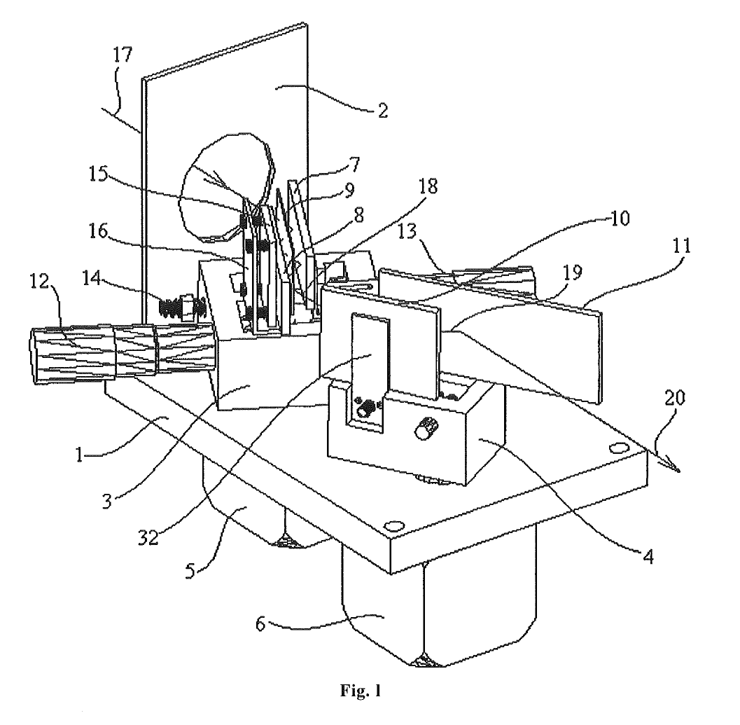

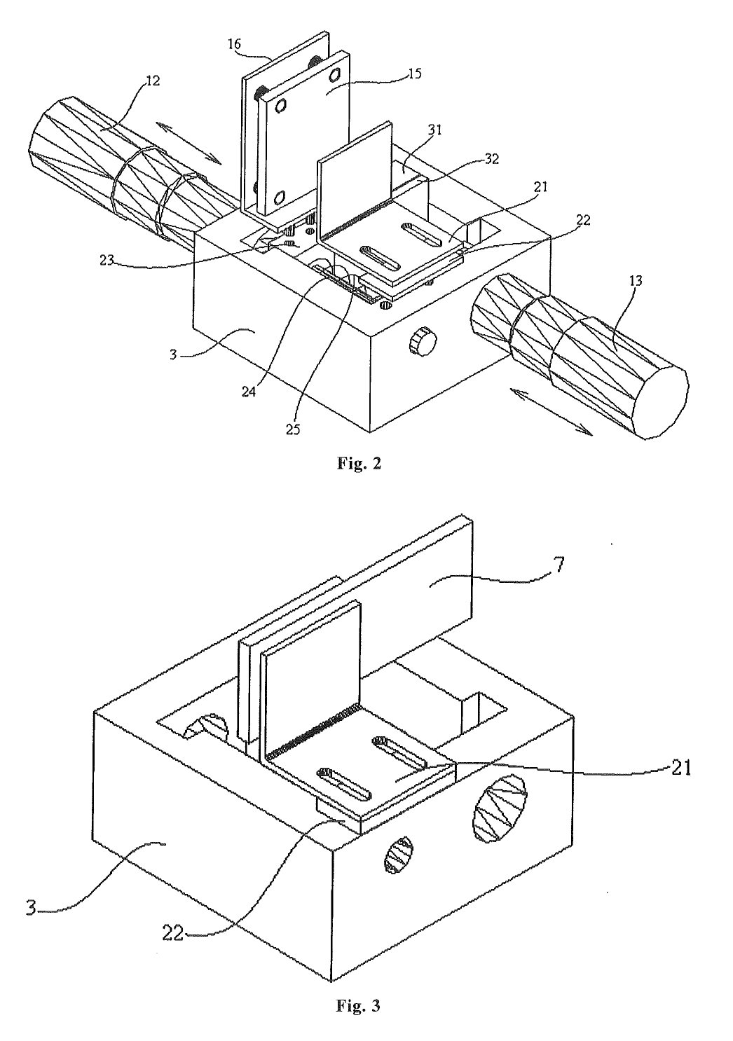

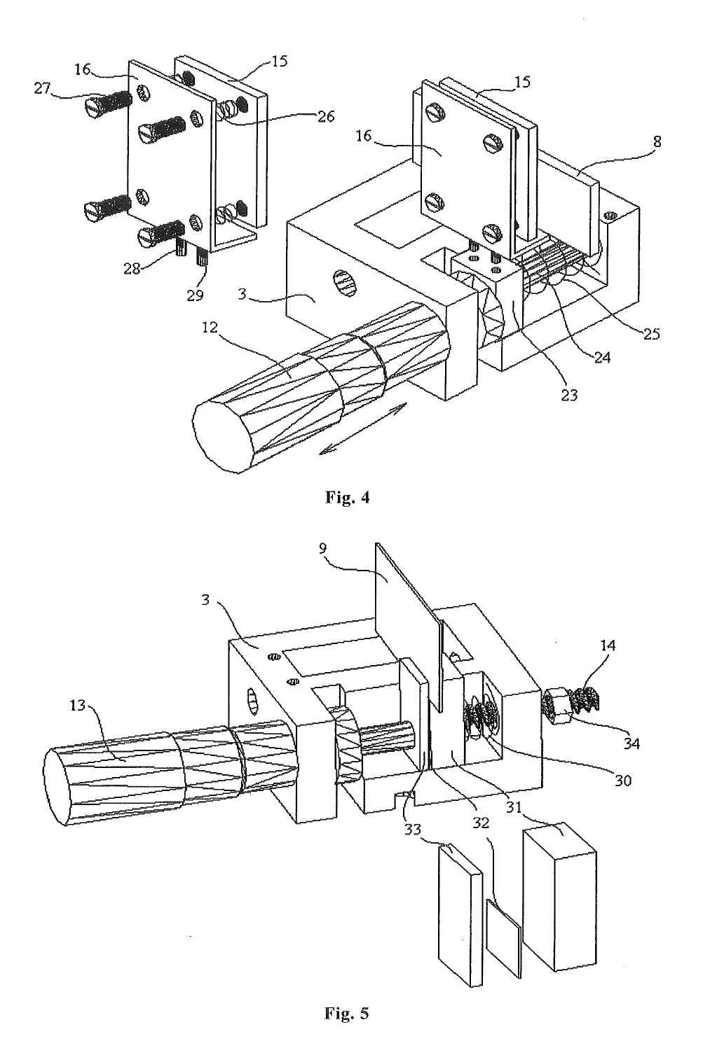

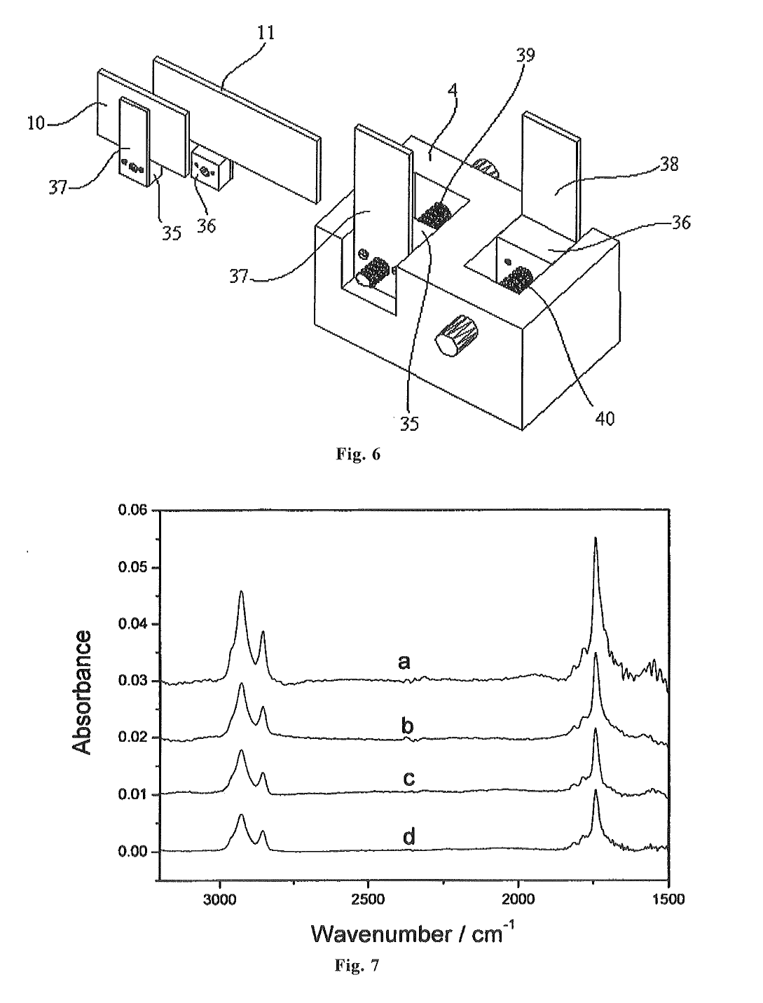

The measurement accessory with multiple transmission-reflections for infrared spectrometer mainly consists of baseplate 1, spile 2, two plane mirrors 7 and 8, two guide mirrors 10 and 11, and two step motors 5 and 6 as shown in FIG. 1. The whole accessory is fixed onto the transmission bracket of Bruker infrared spectrometer by the spile. The step motor is fixed onto the bottom surface of baseplate, and its rotation shaft is extended onto the top surface of baseplate. They are closely fit to plane mirror base 3 and guide mirror base 4 respectively. The rotation angle of step motor is controlled by a single board microcomputer so as to control the rotation angles of Base 3 and Base 4. During measuring, the sample is positioned between plane mirror 7 and plane mirror 8. The position of plane mirror 7 is fixed while the position of plane mirror 8 is accurately controlled by screw micrometer head 12. The position of sample 9 is accurately controlled by screw micrometer head 13. While the infrared beam 17 passing through the spectrometer has got multiple reflections between plane mirror 7 and plane mirror 8, multiple reflections and transmissions occur on the surface of sample 9. The number of times of transmissions and reflections can be changed through changing the distance between plane mirror 7 and plane mirror 8. After ray 18 departs from the sample mirror and is reflected by guide mirror 10, it becomes ray 19. Ray 19 is reflected on the surface of guide mirror 11, and finally outgoing Ray 20 reaches the detector. With the change of angle of plane mirror Base 3, Planer Mirrors 7 and 8 rotate accordingly, so as to change the incidence angle for the detection. When the angle of guide mirror base 4 is changed accordingly, it is possible to allow the ray to reach the detector smoothly.

Folding piece 21 is fixed on plane mirror Base 3. A spacer 22 is inserted between them in order to increase the height of folding piece 21. Adhesive is used to attach plane mirror 7 to folding piece 21. When fixing folding piece 21, the long strip opening allows it to be moved back and forth easily to facilitate replacing of plane mirrors of different thicknesses. One spring 25 is placed between slider 23 on the sliding rail and the base. Straight rod is used for fixing the direction of the spring. The other side of the slider is contacted with screw micrometer head 12. Slider 22 is allowed to move forward and back by stretching out and drawing back of the micrometer head and the spring. Footings 28 and 29 at the bottom of folding piece 16 are fit into two holes on Slider 23, and can be inserted into and withdrawn from them conveniently. Spring 26 is positioned on four top corners between folding piece 16 and straight plate 15 and fixed with screw 27, and the position of straight plate 15 can be changed three-dimensionally. plane mirror 8 is attached to straight plate 15 and can be removed from it easily. Sliders 31 and 33 are used to fix the sample Silicon Piece 9. Similarly, screw micrometer head 13 and Spring 30 are provided on both sides of the slider to allow it to move back and forth. During measuring, Sliding Piece 32 with a same thickness as that of sample 9 to be tested is placed between Sliders 31 and 33 to allow a gap, which is equal to the thickness of sample 9 to be tested, to be provided between two sliders. The sample Silicon Piece 9 can be fixed in the middle. Slider 31 is connected with Screw Stem 14. Since the spring is in the state of contraction, Nut 34 can be used for fixing Slider 31 to allow it to be apart from Slider 33, so that the test sample can be replaced very conveniently. In this way, the distance between sample 9 to be tested and plane mirror 7 and the distance between two plane mirrors i.e. Mirror 7 and Mirror 8 can be controlled accurately.

guide mirrors 10 and 11 are adhered to brackets 37 and 38 respectively, and are fixed on one side of Sliders 35 and 36. Sliders are provided with inside thread. It is possible to make them move back and forth through Screws 39 and 40 so as to control the position of guide mirrors.

The said accessory of the present invention has been used to measure the molecular compositions of a molecular monolayer of NHS-ester applied onto Si—H surface. As shown in FIG. 7, different spectrums are obtained with the face-to-face distance between mirrors changed for an incidence angle of 70°, and as the face-to-face distance of mirrors decreases, the number of times of transmission-reflections increases. As a result, the intensity of infrared absorbance peak is increased accordingly.

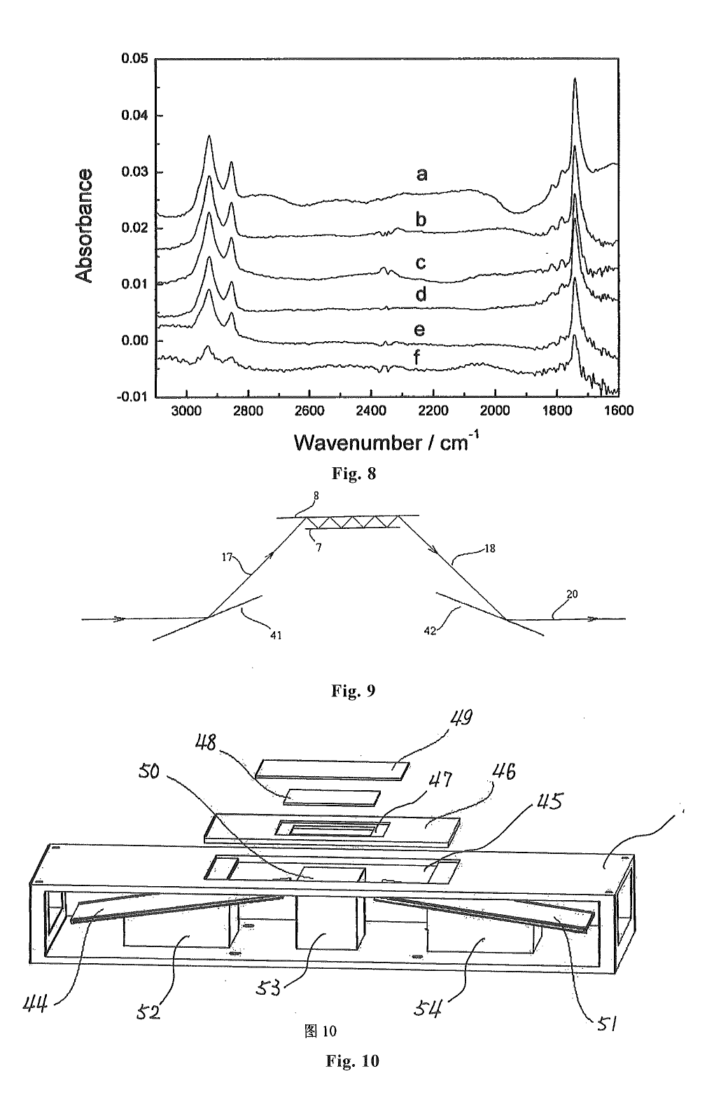

As shown in FIG. 8, it is the infrared spectrum of measurement made at the different incidence angle conditions in which the face-to-face distance (2 mm) between plane mirrors remains unchanged, and a relatively good signal-to-noise ratio is shown for the curves in spectrum. As the incidence angle increases, the number of times of transmission-reflections on the silicon surface decreases. As a result, the intensity of infrared absorbance peak is weakened.

### Embodiment Example 2: Measurement Accessory with Multiple Transmission—Reflections for Infrared Spectrometer

The measurement accessory with multiple transmission-reflections for infrared spectrometer used in this Embodiment Example is basically the same as that used in Embodiment Example 1 with the exceptions of the following:

1. Base 3 of Plane mirrors 7 and 8 can not be rotated, and are not connected with step motor.

2. As shown in FIG. 9, guide mirrors 10 and 11 are changed to guide mirrors 41 and 42, and are positioned in front of or in the rear of the infrared spectrometer path of two plane mirrors, Mirrors 7 and 8, respectively. Two guide mirrors, guide mirrors 41 and 42, are provided respectively with a parallel displacement part, and their bases are connected with step motors. Their positions and orientations can be adjusted guide mirror 41 is adjusted to change the incidence angle of infrared beam for detection, and guide mirror 42 is adjusted to allow outgoing Ray 20 to reach the detector smoothly.

When using the said measurement accessory with multiple transmission-reflections for infrared spectrometer of this Embodiment Example for measuring, the results are as the same as Embodiment Example 1.

### Embodiment Example 3: Measurement Accessory with Multiple Transmission—Reflections for Infrared Spectrometer

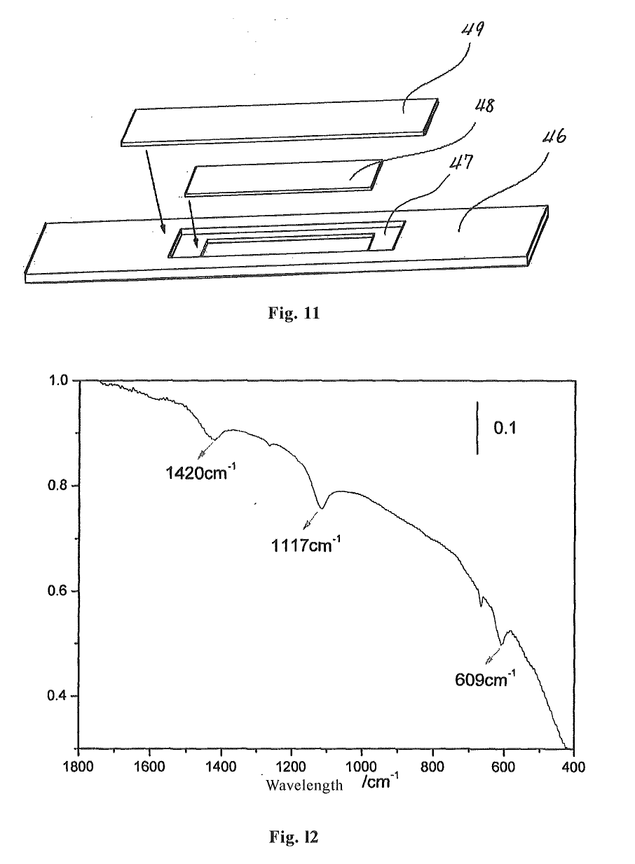

As shown in FIG. 10 and FIG. 11, the measurement accessory with multiple transmission-reflections for infrared spectrometer has a rectangular housing 43. At the front end of rectangular housing 43, there is Inlet 151 of infrared beam emitted from the infrared spectrometer. There is Plane Incoming guide mirror 44 on Wedge Spacer 52 on the baseplate of rectangular housing 43, which is positioned with an angle of 8.2° incident upwards to provide an included angle of 73.6° between the incoming infrared beam and the normal of the mirror face of plane mirror A49. There is a rectangular sample holder Opening 45 on the top plate of rectangular housing 43. At least two opposite sides of sample holder Opening 45 are provided with shoulders caved-in by 0.8 mm. When sample holder 46 is placed into the sample holder opening, the shoulders can support sample holder 46, sample holder 46 is a plate of a thickness of 1.5 mm with a shape matching the sample holder opening, sample opening 47 is made at the center of sample holder 46. There are shoulders caved-in by 0.7 mm around sample opening 47. When sample 48 is positioned into sample opening 47, the shoulders can support sample 48, sample holder is covered by parallel mirror A49, one of two parallel mirrors, and the mirror face of parallel mirror A49 is downward. The distance between sample 48 and parallel mirror A49 is determined by the caved-in depth of the shoulders around sample opening 46. There is parallel mirror B50, one of two parallel mirrors, directly under sample holder 46, which is in parallel with parallel mirror A, parallel mirror B50 is positioned on Rectangular Wedge 53 with the mirror face being upward. The distance between two parallel mirrors is 1.4 m. The length of parallel mirror B50 is smaller than that of the sample opening in order to allow the incoming infrared spectrometer after reflection of Incoming guide mirror 44 to enter into sample opening 47 of sample holder 46, and to go to outgoing guide mirror 51 after multiple reflections taking place between two parallel mirrors, parallel mirrors 49 and 50. The outgoing guide mirror is a plane mirror inclined downwards, which is located on Wedge Spacer 54 on the baseplate of rectangular housing 43. There is an outlet of outgoing infrared spectrometer at the rear end of rectangular housing 43, outgoing guide mirror 51 guides the outgoing infrared spectrometer to the detector of infrared spectrometer.

The said accessory has been used to measure the compositions of substitutional carbon atoms, clearance oxygen atoms, impurities of phosphorus/boron, etc., in the poly-silicon piece. Generally, the transmission infrared spectrum is used for measuring the compositions of substitutional carbon atoms and clearance oxygen atoms in the poly-silicon piece. But in considerably many cases, it is difficult to determine the absorbance related to the trace carbon and oxygen in the infrared transmission spectrum, or the absorbance is very weak, make the further quantitative analysis become difficult. It is possible to use the said accessory utilizing multiple transmission-reflections to allow the characteristic infrared absorbance peak to be enhanced remarkably. As shown in FIG. 12, it is an infrared spectrum obtained by using the said accessory utilizing the multiple transmission-reflections with a poly-silicon piece of a thickness of 0.15 mm used as the sample and with the infrared spectrometer at Brewster angle to be transmitted through the silicon piece for 8 times. A clear absorption band appears within the 1600 cm⁻¹˜500 cm⁻¹ spectrum limits in the spectrum. The absorbencies related to the clearance oxygen atoms and the subrogated carbon atoms are located at the wavenumber 1117 cm⁻¹ and the wavenumber 609 cm⁻¹ respectively. In the spectrum, the absorption band located at 1420 cm⁻¹ is formed by superposition of P(═O) band and B(═O) band.

In accordance with the Beer Law, The concentration of clearance oxygen and subrogated carbon is proportional to the absorption factor α:

$$α = \frac{1}{d} ln \frac{{T}_{0}}{T}$$

$$C = k * α$$

d—Actual optical path length of infrared spectrometer passing through the silicon piece (the value is related to the incidence angle of infrared spectrometer, thickness of silicon piece and the number of times of transmissions), cm;

T₀—Base line transmittance at the peak absorption point, %;

T—Peak transmittance,%;

C—Concentration, ppmA;

k—Correction factor, ppm A/cm⁻¹

The correction factor at the ambient temperature (300 K) can be obtained from ASTM Standard (ASTMFl21) as follows

k[oxygen]=9.63 ppm A/cm⁻¹

k[carbon]=2.2 ppm A/cm⁻¹

For the specific calculation of the concentration of clearance oxygen and subrogated carbon, it is also possible to refer to the National Standard of the People's republic of China (GB/T 1558.1997).

Based on the 1117 cm-1 peak transmittance values of T0 and T as shown in FIG. 12, K(oxygen) value and the d value (0.167 cm), the concentration of oxygen C[Oxygen] can be calculated:

$$c [ oxygen ] = k [ oxygen ] * α = 9.63 * \frac{1}{0.167} In \frac{0.829}{0.757} = 5.24 ppm A$$

Based on the 609 cm⁻¹ peak transmittance values of T₀ and T as shown in FIG. 12, K(carbon) value and the d value (0.167 cm), the concentration of oxygen C[carbon] can be calculated:

$$c [ carbon ] = k [ carbon ] * α = 2.2 * \frac{1}{0.167} In \frac{0.549}{0.497} = 1.31 ppm A$$

For the compositions of P(═O) and B(═O) impurities, it would be OK to select and use the ratio of 1420 cm⁻¹ peak transmittance to the peak transmittance of SiO at 1117 cm⁻¹ for the calibration curve.

We claim:

1. A measurement accessory with multiple transmission-reflections uses for an infrared spectrometer, laid accessory is arranged in the sample cavity of the infrared spectrometer, wherein said accessory includes two parallel plan mirrors (7, 8) and a sample holder fixed between the two mirrors (7, 8); said sample holder can fix the sample piece (9) between the two plane mirrors (7, 8) and make the sample piece parallel with plane mirrors (7, 8); during measuring, the infrared beam emitted from infrared spectrometer (17) forms a certain angle incident to the space between said plane mirrors and reflects for several times between the two parallel plane mirrors (7, 8) and the sample piece (9) is measured with multiple transmission-reflections by the infrared spectrometer, then the infrared spectrometer (20) enters into the detector of infrared spectrometer.

2. A measurement accessory according to claim 1 wherein the said plane mirrors (7, 8) are provided with a parallel displacement Part (12) for adjusting the distance between two plan mirrors (7, 8).

3. A measurement accessory according to claim 1 wherein the said sample holder is provided with a parallel displacement part (13) for adjusting the position of sample between the Plan mirrors (7, 8).

4. A measurement accessory according to claim 1 wherein the said two plane mirrors (7, 8) and the sample holder are provided with a common rotary platform (3) for adjusting the incidence angle of infrared spectrometer entering into the plane mirrors (7, 8).

5. A measurement accessory according to claim 1 wherein the said guide mirrors with their position or/and angle changeable are provided in the rear of infrared spectrometer path of two plan mirrors (7, 8) for adjusting the direction of infrared beam Path (18) and enhancing the ray signals to be received by the detector.

6. A measurement accessory according to claim 4 wherein the said guide mirrors (10 and 11) with their position or/and angle changeable are provided in the rear of infrared spectrometer path of two Plane mirrors (7, 8) for adjusting the direction of infrared beam Path (18) and enhancing, as much as possible, the ray signals to be received by the detector.

7. A feature according to claim 1, wherein the said guide mirror (41) with the position and/or angle changeable is provided in front of the infrared spectrometer (17) of two Plane mirrors (7, 8) for adjusting the infrared beam (17) entering into two Plane mirrors (7, 8), and the incidence angle for measuring can be changed.

8. A measurement accessory according to claim 4 wherein the said guide mirror (41) with the position and/or angle changeable is provided in front of the infrared beam (17) of two Plane mirrors (7, 8) for adjusting the infrared beam (17) entering into two Plane mirrors (7, 8), and the incidence angle of infrared beam entering into two plane mirrors can be changed.

9. A measurement accessory according to claim 5 wherein the said guide mirror (41) with the position and/or angle changeable is provided in front of the beam (17) of two plane mirrors (7, 8) for adjusting the infrared beam (17) entering into two plane mirrors (7, 8), and the incidence angle of infrared beam entering into two plane mirrors can be changed.

10. A measurement accessory according to claim 1 wherein the said measurement accessory is provided with the said rectangular housing (43), the said inlet of incoming infrared beam from the infrared spectrometer is provided at the front end of the said rectangular housing (43), the said Plane Incoming guide mirror (44) is provided on the baseplate of rectangular housing (43), which is positioned with an angle incident upwards to provide an inclined angle of 60°˜88° between the incoming infrared beam and the normal of the mirror face of the said plane mirror A (49), the said rectangular sample holder Opening (45) is provided on the top plate of the said rectangular housing (43), at least two opposite sides of the said sample holder Opening (45) are provided with caved-in shoulders; When the said sample holder (46) is placed into the sample holder opening, the shoulders can support the said sample holder (46) and the said sample holder (46) is a plate of a certain thickness with a shape matching the sample holder opening; and, the said sample opening (47) is provided at the center of the said sample holder (46); the said caved-in shoulders are provided around the said sample opening (47), and when the said sample (48) is positioned into the said sample opening (47), the shoulders can support sample (48); The said sample holder (46) is covered by the said parallel mirror A (49), one of two parallel mirrors, and the mirror face of the said parallel mirror A (49) is downward, and the distance between the said sample (48) and the said parallel mirror A (49) is determined by the caved-in depth of the shoulders around the said sample opening (47); The said parallel mirror B (50), one of two parallel mirrors, is provided directly under the said sample holder (46), which is in parallel with the said parallel mirror A (49); The said parallel mirror B (50) is positioned with the mirror face being upward, the length of parallel mirror B (50) is smaller than that of the said sample opening (47) in order to allow the incoming infrared beam after reflection of Incoming guide mirror (44) to enter into sample opening (47) of the said sample holder, and to go to outgoing guide mirror (51) after multiple reflections taking place between two parallel mirrors; The said outgoing guide mirror (51) is a plane mirror inclined downwards, which is located on the baseplate of rectangular housing (43), and with an outlet of outgoing infrared beam provided at the rear end of the said rectangular housing (43), the said outgoing guide mirror (51) guides the outgoing infrared beam to the detector of infrared spectrometer.
